(19) United States
(12) Patent Application Publication
(10) Pub. No.: US 2003/0122352 A1
(43) Pub. Date: Jul. 3, 2003

(54) Device for mounting accessory wheels on stroller

(76) Inventor: Ruben Moscovich, Port St. Lucie, FL (US)

Correspondence Address: Greigg, & Greigg, P.L.L.C., Unit One, 1423 Powhatan Street, Alexandria, VA, 22314, US

(21) Appl. No.: 10/213,381

(22) Filed: Aug. 7, 2002

Related U.S. Application Data
(60) Provisional application No. 60/310,242, filed on Aug. 7, 2001.

(51) Int. Cl. B62B 7/08; B62B 7/00

(52) U.S. Cl. 280/648

(57) ABSTRACT

An accessory wheel adapter device for use with a child stroller having a frame supported by front and rear wheels in a first stable position for movement on a surface, the frame including upwardly and rearwardly extending side frame members supporting handles at their upper ends, and a seat mounted on the frame for supporting a child in a generally upright seated position, the adapter including a pair of auxiliary wheels and a device for mounting the auxiliary wheels rearwardly of said rear wheels at a location permitting the stroller to be tilted about said rear wheels to a second stable position in which the stroller is supported on the rear wheels and the auxiliary wheels and the seat is in a generally reclined position to support a child in a supine position, and a mounting device for releasably attaching the adapter on the stroller frame.

### CROSS-REFERENCE TO RELATED APPLICATION

This application claims the priority of Provisional Patent Application Serial No. 60/130,242, filed Aug. 7, 2001.

### BACKGROUND OF THE INVENTION

1. Field of the Invention

This invention relates to improvements in baby strollers, in particular, the type of stroller that folds in half compactly and has handles that mimic those on an umbrella. One brand of this type of stroller is called the UMBROLLER®.

The problem for which the invention provides a solution is the comfortable, safe transport of a sleeping baby in an umbrella-type stroller.

Young babies are not able to sit comfortably upright and may slouch or bob their heads uncomfortably in a standard umbrella stroller. Also, on outings with babies and toddlers, it is very common for an observer to see that the motion of the stroller soothes the child and helps him to fall asleep. In a standard umbrella-type stroller, the sling-style seat does not recline, and thus the sleeping child simply slumps over while seated in this upright position. To compensate for this uncomfortable posture necessitated by the fixed seat, some parents will tilt the stroller backwards and then push it on its back wheels to allow the child to rest more comfortably, that is, in a supine position, but this practice of balancing the stroller on two wheels is inherently unsafe.

The Prior Art Relating to the Invention

U.S. Pat. No. 4,072,318 is considered a relevant prior art reference because it discloses an invention, which performs a function similar to the function performed by the stroller reclining mechanism comprising the present invention. However, the structure of the invention shown in 4,072,318 is different from that of the invention. U.S. Pat. No. 4,805,928 discloses another example of an invention, which is relevant to the extent that a similar function is disclosed. Structural differences exist between this invention and the invention shown in the patent document 4,805,928. U.S. Pat. No. 4,986,564 is relevant to the disclosed function of the invention, but it also defines structural differences with what is disclosed in this invention.

### OBJECTS OF THE INVENTION

This invention has as its principle object the provision of an accessory for use with a stroller of the above-described type, which provides greater safety to the sleeping infant.

The invention has as another object the provision of an accessory for use with a stroller of the above-described type which provides greater stability to the stroller in its tilted backwards position by virtue of an ancillary set of wheels which come into play in that position.

The invention has as yet another object the provision of an accessory for use with a stroller of the above-described type which provides an ancillary set of handles which the parent may use to push the stroller more comfortably in its reclined backwards position.

The invention has as still another object the provision of an accessory for use with a stroller of the above-described type that provides for adjustment of the angle of recline of the stroller when using the accessory.

### SUMMARY OF THE INVENTION

The invention defines an accessory to fit umbrella-type strollers. A universal fitting adapter is provided that allows the accessory to attach to the normal handles of the umbrella-type stroller. It would then be folded outwardly and downwardly to create a third pair of wheels spaced rearwardly of the back wheels of the stroller. In use it would allow the umbrella-type stroller to be tilted back so that a sleeping infant or child could assume a supine position and yet could be pushed around without the fear of the stroller tipping over. Since most umbrella strollers do not have the capability of reclining the seat, parents usually recline the entire stroller. With this invention the stroller can be reclined in a secure and safe manner. The angle of recline can be adjusted by adjusting the length of the adapter legs relative to the normal handles of the stroller.

The invention will permit the stroller to be reclined in a varying number of positions. The accessory could be made out of either strong plastic or a lightweight, strong metal. It will be able to fit all non-reclining strollers and be foldable along with the strollers so that once the accessory has been mounted on a stroller, it need not be taken off. The accessory will have two wheels on the bottom extremity so that the stroller can be pushed in the reclined position safely. The opposite handle portion of the accessory will also be adjustable to provide different longitudinal extent, and thus allow for different height positions for taller parents. The accessory will be connected to the frame rails of the normal stroller so that the handles are mounted right below the existing curved (U shaped) handles of the umbrella-type stroller. The handles of the accessory can also be swivelled upwardly and inwardly toward the stroller seat so that the accessory will not be in the way when one is storing the stroller.

### BRIEF DESCRIPTION OF THE DRAWINGS

FIG. 1 shows a side elevational view of an umbrella-type stroller to which the accessory has been fitted, with the full lines showing the accessory extended for use and the phantom lines showing the stroller in its normal, upright position; and

FIG. 2 shows a rear view of the accessory alone before it is mounted on the normal stroller handle shafts.

### DESCRIPTION OF THE PREFERRED EMBODIMENT

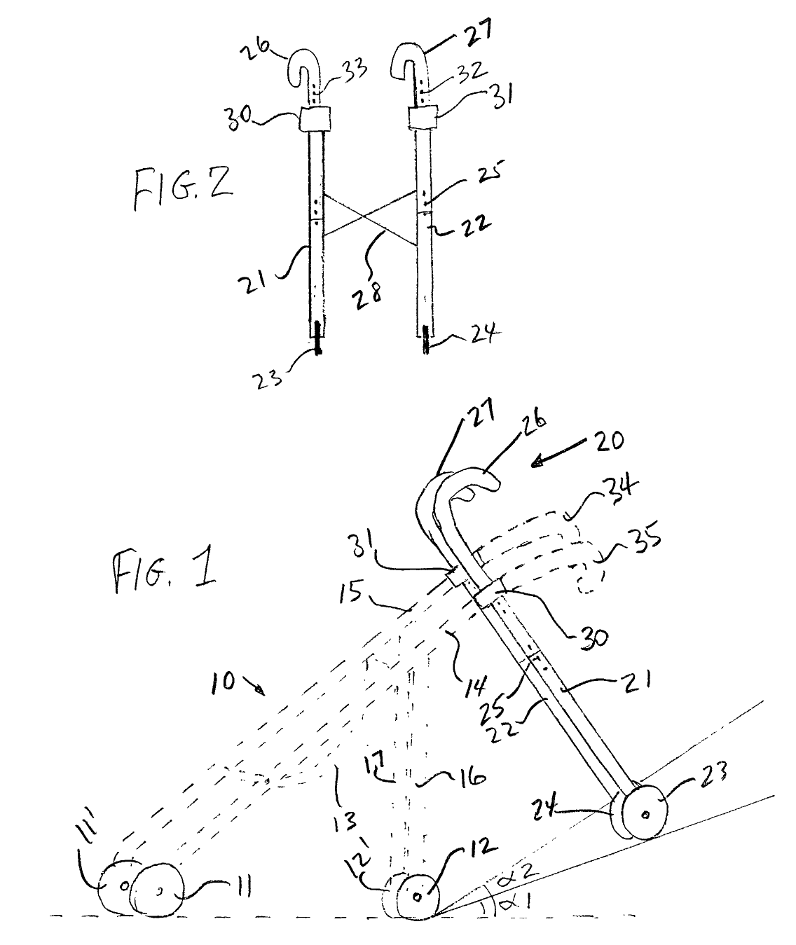

FIG. 1 shows the invention mounted as an accessory 20 on an umbrella-type stroller 10 having front wheel sets (11, 11′) and rear wheel sets 12,12′ and a sling-type seat 13. FIG. 1 shows a stroller of the above-described type in two positions. Those two positions will now be described.

In the phantom dashed line view the stroller is shown in its normal position of use. In a full line view the accessory of the invention is shown attached to the handles or frame members of the stroller and oriented in a position for use that would allow the stroller to be tilted backwards safely in order to provide a reclined position for a sleeping child. In the alternate full line view featuring the use of the accessory, there are shown two of several possible angles of orientation of the stroller seat with respect to the ground. Angle alpha 1 is a lesser angle of recline of the stroller seat provided when the lower legs of the accessory are extended farther out from the handles of the stroller. Angle alpha 2 shows a greater angle of recline of the stroller seat achieved when the lower legs of the accessory are shortened.

The accessory would preferably be made of lightweight metal and/or a durable plastic. The invention is shown attached at joining elements (or connecting clamps) 30, 31 to the normal handles 14, 15 of the umbrella-type stroller, thereby providing an extra set of legs 21, 22 respectively carrying ancillary wheels 23, 24 that would allow the stroller to be tipped back, yet still be pushed in a safe and stable manner.

Specifically, the invention includes two legs 21, 22 provided with telescoping means indicated generally at 25. Each of the legs 21, 22 are provided at a first extremity with a respective wheel and would be provided at their opposite extremities with curved handles 26, 27 similar to those found on the stroller itself. They would attach to the stroller just below the normal stroller handles (34, 35) with adjustable clamping mechanisms. These wheeled legs 21, 22 would be connected to each other by means of a folding, “X”-shaped support 28 that would mimic the folding action of the stroller, thus allowing the accessory legs to fold together when the stroller was collapsed for storage. The legs 21, 22 would also be capable of folding from just below the connecting clamps in a forward direction to rest against the frame members of the stroller frame. When attached to the stroller, the invention would not interfere with the ability of the stroller to fold compactly and would not have to be removed in order to fold open the stroller in the usual manner. For use, the legs 21, 22 would be folded down to a right angle with respect to the normal stroller handles shafts and then adjusted to the desired length to achieve a chosen height for the accessory handles by engaging a selected pin-in-hole position corresponding to the length of the adapter desired. The stroller could then be tilted back, transferring the weight of the baby in a stable manner onto its back wheels and the wheels of the invention.

The telescoping action of the invention would be achieved in a preferred embodiment by a pin-in-hole adjustment mechanism in each adapter leg and in each corresponding stroller handle. This would allow the user to adjust the angle to which the stroller is reclined. The approximate height from the ground to the clamps in the reclined position thus would be adjustable from about 15 inches to about 23 inches. The height adjustment mechanisms in the handles would allow the invention to adjust comfortably to the height desired by the adult pushing the stroller. With the stroller adapter adjusted to its minimum length the stroller would recline a greater amount corresponding to the angle alpha 2 shown in FIG. 1. Adjusted to its maximum longitudinal extent the adapter would allow the stroller to recline at a lesser angle, indicated in FIG. 1 as the angle alpha 1.

A friction or other mechanical lock pivotable between two positions could achieve the adjustment of the accessory legs and handles from a first position folded away out of use into a second position ready for use. The particular style of lock mechanism is not per se of great importance to the invention. In addition, since the invention is conceived as an accessory for use on strollers that have already been made and purchased, the clamping mechanism must be able to compensate for different handle diameters used on different strollers. A number of prior art means exist to achieve this function, which again is not considered part of the novelty of the invention.

The invention could be offered in various materials and colors and would offer a comfortable alternative to leaving a sleepy child in an upright position in a standard umbrella-type stroller. The inventor believes that the invention would fulfill a long felt need for a means of safely reclining a baby in an umbrella-type stroller.

The appealing features of the invention include its ease of use, practical nature, safety, and the increased comfort it would provide for both the parent and the child. The invention would allow parents to take advantage of all the conveniences of an umbrella-type stroller—the compact design, portability, easy collapsibility, and low cost—while also providing a more comfortable ride for the baby or young child. It would allow the parent or another care giver to recline the stroller safely, providing a much more comfortable position for the child or young infant without compromising the stability of the stroller. In addition, it provides an alternate position from which to steer the stroller, which would allow the parent to remain standing more or less erect instead of bent over holding the normal handles of the stroller substantially parallel to the ground.

The foregoing relates to preferred exemplary embodiments of the invention, it being understood that other variants and embodiments thereof are possible within the spirit and scope of the invention, the latter being defined by the appended claims.

I claim:

1. In a child stroller having a frame (10) defined by a pair of spaced side frame members (14,15) terminating at one end in first handle means (34, 35) and at an opposite end in means supporting a set of forward wheels (11,11′), a pair of rear frame members (16,17) each connected at one end to a respective one of said pair of side frame members and provided at opposite ends with means supporting a set of rear wheels (12,12′), a seat (13), support means for mounting said seat in place with respect to said frame members to support a child in a seated position, the improvement comprising further frame means (20) mounted on said frame, said further frame means provided with a third set of wheels at one extremity thereof, wherein said stroller can be moved from a stable first position resting on said first and second sets of wheels into a stable second position resting upon said second and third sets of wheels to position the seat in a reclined position, whereby a sleeping baby may rest more comfortably in a supine position upon the now reclined seat.

2. A stroller according to claim 1, wherein said further frame means is movable between a first stowed position into a second position for use.

3. A stroller according to claim 1, wherein said further frame means is provided with second handle means (26, 27).

4. A stroller according to claim 3, further comprising clamp means (30, 31) provided for releasably locking said further frame means to said side frame members and against relative movement there between.

5. A stroller according to claim 4, wherein said clamp means comprises at least one pin means mounted on one of said side frame members or said further frame means for projection into at least one slot provided on the other of said side frame members or said further frame means and capable of producing a positive connection there between.

6. A stroller according to claim 4, wherein said clamp means comprises a spring-biased mechanical locking element coupled to said further frame means and capable of producing a positive connection between it and said side frame member.

7. A stroller according to claim 1, wherein said further frame means comprises elongated shaft means and said shaft means is provided with adjustment means (25) for adjusting the length of said shafts means with respect to said side frame members.

8. A stroller according to claim 3, wherein said further frame means is provided with locking means (32, 33) to adjust the positions of said second handle means (26, 27) relative to said clamp means.

9. A child stroller comprising a frame, a pair of front and a pair of rear laterally spaced wheels supporting the frame in a first position, a seat mounted on the frame in position to support a child in a substantially upright seated position, and a pair of laterally spaced auxiliary wheels, said auxiliary wheels being mounted rearwardly of said rear wheels and at a level above said front and rear wheels when the stroller is in the first position, said auxiliary wheels being positioned to cooperate with said pair of rear wheels to support the stroller in a stable second position in which the seat is in a reclined position to enable a child therein to rest in a supine position.

10. The stroller defined in claim 9, wherein said pair of auxiliary wheels are mounted one on the end of each of a pair of elongated supports, and wherein said elongated supports are mounted on said frame for movement from a non-use position to a use position, whereby the stroller may be tilted about said pair of rear wheels to rest stably on said rear wheels and said auxiliary wheels in said second position.

11. The stroller defined in claim 10, further comprising second handle means positioned for use when the stroller is in said second position.

12. The stroller defined in claim 10, further comprising clamp means for supporting said elongated supports, said clamp means being operable to retain said auxiliary wheels in said non-use position and in said use position selectively.

13. The stroller defined in claim 12, wherein said clamp means includes movably operable spring biased detent means.

14. Adapter means for use with a child stroller having a frame supported by front and rear wheels in a first stable position for movement on a surface, the frame including upwardly and rearwardly extending side frame members supporting handle means at their upper ends, and a seat mounted on the frame for supporting a child in a generally upright seated position, said adapter means including a pair of auxiliary wheels and means mounting said auxiliary wheels rearwardly of said rear wheels at a location to permit the stroller to be tilted about said rear wheels to a second stable position in which the stroller is supported on said rear wheels and said auxiliary wheels and the seat is in a generally reclined position to support a child in a supine position, and mounting means for releasably attaching said adapter means on the stroller frame.

15. The adapter defined in claim 14, wherein said means mounting said auxiliary wheels comprises a pair of elongated support members having upper and lower ends, said lower ends supporting said auxiliary wheels, and mounting means releasably mounting said upper end portion on said side frame members.

16. The adapter defined in claim 15, wherein said mounting means comprises clamp means supporting said elongated frame members for movement on said stroller from a use position to a non-use position.

17. The adapter defined in claim 14, further comprising second handle means for use to propel the stroller when the stroller is in the second position.
